(19) United States
(12) Patent Application Publication
(10) Pub. No.: US 2026/0315837 A1
(43) Pub. Date: Oct. 15, 2026

(54) MOUNTING BRACKET ASSEMBLIES FOR HOLDING BREATHING APPARATUSES

(71) Applicant: H.O. Bostrom Company, Inc., Waukesha, WI (US)

(72) Inventors: Paul C. Bostrom, Waukesha, WI (US); Mitch Yehle, Waukesha, WI (US)

(73) Assignee: H.O. Bostrom Company, Inc., Waukesha, WI (US)

(21) Appl. No.: 19/640,138

(22) Filed: Apr. 6, 2026

Related U.S. Application Data
(60) Provisional application No. 63/786,094, filed on Apr. 9, 2025.

(51) Int. Cl. A62B 25/00

(52) U.S. Cl. CPC A62B 25/00

(57) ABSTRACT

A mounting bracket assembly configured for releasably holding an elongated self-contained breathing apparatus (SCBA). A frame is movably coupled to a base. A head is pivotably coupled to the frame so as to move therewith, wherein the head is pivotable between a closed position to retain the SCBA with the frame and an open position in which the SCBA is removeable from the frame. A latch is engageable to lock the head in the closed position. The latch is coupled to the frame to move therewith relative to the base. The latch is operatively coupled such that moving the frame relative to the base causes the latch to disengage to thereby allow the head to pivot towards the open position.

### CROSS REFERENCE TO RELATED APPLICATION

This application claims the benefit of U.S. Provisional Patent Application No. 63/786,094, filed Apr. 9, 2025, which is incorporated herein by reference in its entirety.

### FIELD

The present invention relates to breathing apparatuses, and particularly to mounting bracket assemblies for holding breathing apparatuses.

### BACKGROUND

This section includes discussion intended to help understand various aspects of the subject matter presently disclosed below. This discussion should not be interpreted as constituting an admission of prior art.

The following are incorporated herein by reference in entirety.

U.S. Pat. No. 8,469,324 discloses a mounting bracket assembly including a clamping arrangement mounted for vertical movement on a mounting structure and moveable between an engaged position and a disengaged position relative to a self-contained breathing apparatus held in the mounting bracket assembly. A camming arrangement is located between the clamping arrangement and the mounting structure for permitting and preventing vertical movement of the clamping arrangement relative to the mounting structure. A powered latching mechanism is engageable with a portion of the clamping arrangement for providing unlatched and latched positions. A control arrangement separate from the powered latching mechanism is operatively connected thereto to selectively control the powered latching mechanism and effect release of the self-contained breathing apparatus from the latched position when the vehicle is in a stationary and parked condition.

U.S. Pat. No. 8,052,209 discloses a mounting bracket assembly including a clamping arrangement mounted for vertical movement on a mounting structure. The clamping arrangement is moveable between an engaged position and a disengaged position relative to a self-contained breathing apparatus held in the mounting bracket assembly. A camming arrangement is located between the clamping arrangement and the mounting structure for permitting and preventing vertical movement of the clamping arrangement relative to the mounting structure. A powered latching mechanism is engageable with a portion of the clamping arrangement for providing unlatched and latched positions. A control arrangement separate from the powered latching mechanism is operatively connected thereto to selectively control the powered latching mechanism and effect release of the self-contained breathing apparatus from the latched position when the vehicle is in a stationary and parked condition.

U.S. Pat. No. 7,963,597 discloses a mounting bracket assembly for releasably holding a self-contained breathing apparatus. The assembly includes a mounting plate, a clamping arrangement secured on an upper portion of the mounting plate and moveable between an unlatched position and a latched position relative to the self-contained breathing apparatus, a guide connected on an intermediate portion of the mounting plate and a support structure mounted on a lower portion of the mounting plate. The clamping arrangement includes a pivot arm having an actuator plate biased forwardly of the mounting plate in the unlatched position, and a self-contained breathing apparatus engaging clamp swung upwardly above the mounting plate in the unlatched position. The clamping arrangement further includes a latching mechanism engageable and disengageable with the pivot arm for providing latched and unlatched positions. Movement of the self-contained breathing apparatus against the actuator plate automatically swings and locks the clamp downwardly on an upper end of the self-contained breathing apparatus, and causes the pivot arm to engage the latching mechanism in the latched position with the guide centering and retaining an intermediate portion of the self-contained breathing apparatus and the support structure supporting a lower portion of the self-contained breathing apparatus.

U.S. Pat. No. 4,056,017 discloses a mechanical linkage for moving an oxygen bottle disposed in a horizontal position at a first location on a fire engine to a vertical position at a second location. The linkage permits pivoting the oxygen bottle horizontally from the first location to the second and then pivoting the oxygen bottle vertically from the horizontal position to the vertical position.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

One aspect of the present disclosure generally relates to a mounting bracket assembly configured for releasably holding an elongated self-contained breathing apparatus (SCBA), the mounting bracket assembly comprising a base and a frame movably coupled to the base, a head pivotably coupled to the frame so as to move therewith relative to the base, wherein the head is pivotable between a closed position to retain the SCBA with the frame and an open position in which the SCBA is removeable from the frame, and a latch engageable to lock the head in the closed position, wherein the latch is coupled to the frame so as to move therewith relative to the base, and wherein the latch is operatively coupled such that moving the frame relative to the base causes the latch to disengage to thereby allow the head to pivot towards the open position.

In certain examples, a cable is coupled to the latch, wherein moving the frame relative to the base tensions the cable to disengage the latch.

In certain examples, the frame is movably coupled to the base such that the frame is movable only non-orthogonally relative to the base.

In further examples, the latch is configured to be disengaged by simultaneously moving the frame upwardly and towards the base.

In certain examples, the frame is movable relative to the base between a first position and a second position, wherein gravity forces the frame towards the first position, and wherein the latch is engaged when the frame is in the first position.

In certain examples, a damper resists movement of the frame towards the second position so as to prevent accidental disengagement of the latch.

In further examples, a damper resists movement of the frame towards the first position to allow the latch to disengage before the frame moves away from the second position. In further examples, the damper is a double acting damper that also resists movement of the frame towards the second position so as to prevent accidental disengagement of the latch.

In certain examples, the head is coupled to the frame via a carriage that is vertically movable relative to the base, wherein the head is coupled to the carriage so as to move therewith and the head is configured to vertically clamp the SCBA to secure the SCBA to the frame, further comprising a lock selectively engageable to prevent vertical movement of the carriage relative to the base, and a handle is operatively coupled to the lock and configured to be manually moved by a user, wherein moving the handle disengages the lock to allow for vertically positioning the head for clamping the SCBA.

In further examples, the handle is pivotable by the user to disengage the lock.

In further examples, the handle is pivotably coupled to the carriage to move therewith, wherein the lock comprises a rack coupled to the frame, and wherein a pawl is selectively engageable with the rack by pivoting the handle.

In further examples, the handle is biased by a spring into a lock position in which the lock is engaged, whereby manually moving the handle overcomes the spring to disengage the lock.

In further examples, the base is configured to be coupled to a vehicle seat and the handle is pivotable within a plane that is substantially parallel to a back of the vehicle seat.

In further examples, the head clamps down on the SCBA, and wherein the handle is manually moved upwardly to disengage the lock.

In certain examples, the head is movably coupled to an arm that extends away from the base, wherein a plurality of openings extend through the arm, and wherein adjacent openings within the plurality of openings overlap so as to be open to each other, further comprising a lock selectively engageable with the plurality of openings in the arm, wherein selecting which of the plurality of openings the lock engages adjusts and locks a position of the head relative to the arm for securing the SCBA to the seat.

In further examples, the plurality of openings comprises a plurality of crescent-shaped openings.

In further examples, the lock comprises a plunger insertable within the plurality of openings to lock the position of the head relative to the arm.

Certain examples further include a foot having a first end coupled to the frame and extending away therefrom to a second end with a midsection therebetween, wherein the foot is configured to support the SCBA, wherein the foot has a ramp that ramps downwardly from the first end to the midsection, and a cup positioned in the midsection, wherein the cup is configured to receive a valve of the SCBA therein to prevent movement of the valve relative to the foot, wherein the ramp is configured to guide the valve towards the midsection and thereby assist a user in positioning the valve of the SCBA in the cup.

In further examples, the cup has an opening comprising at least two different shapes to thereby accommodate different configurations for the valve.

In further examples, the cup is removable from the midsection and positionable therein in at least two positions, and wherein the cup has an opening that is asymmetrical such that in a first of the at least two positions the opening is configured to receive a first valve type as the valve therein and in a second of the at least two positions the opening is configured to receive a second valve type as the valve therein.

Another independent aspect of the present disclosure generally relates to a mounting bracket assembly for a vehicle seat for releasably holding an elongated self-contained breathing apparatus (SCBA). The mounting bracket assembly comprises a base configured to be coupled to the vehicle seat; a carriage vertically movable relative to the base; a head coupled to the carriage so as to move therewith, wherein the head is configured to vertically clamp the SCBA to secure the SCBA to the vehicle seat; a lock selectively engageable to prevent vertical movement of the carriage relative to the base; and a handle operatively coupled to the lock and configured to be manually moved by a user, wherein moving the handle disengages the lock to allow for vertically positioning the head for clamping the SCBA.

In certain examples, the handle is pivotable by the user to disengage the lock.

In certain examples, the handle is pivotably coupled to the carriage to move therewith, the lock comprises a rack coupled to the base, and a pawl is selectively engageable with the rack by pivoting the handle.

In certain examples, the handle is biased by a spring into a lock position in which the lock is engaged and manually moving the handle overcomes the spring to disengage the lock.

In certain examples, the handle is pivotable within a plane that is substantially parallel to the back of a vehicle seat.

In certain examples, the head clamps down on the SCBA, and the handle is manually moved upwardly to disengage the lock.

Another aspect according to the present disclosure generally relates to a mounting bracket assembly for a vehicle seat for releasably holding an elongated self-contained breathing apparatus (SCBA). The mounting bracket assembly comprises a base configured to be coupled to the vehicle seat; an arm extending away from the base, wherein a plurality of openings extend through the arm, and wherein adjacent openings within the plurality of openings overlap so as to be open to each other; a head movably coupled to the arm; and a lock selectively engageable with the plurality of openings in the arm. Selecting which of the plurality of openings the lock engages adjusts and locks a position of the head relative to the arm for securing the SCBA to the seat.

In certain embodiments, the plurality of openings comprises a plurality of crescent-shaped openings.

In certain embodiments, the lock comprises a plunger insertable within the plurality of openings to lock the position of the head relative to the arm.

Another aspect according to the present disclosure generally relates to a mounting bracket assembly for a vehicle seat for releasably holding an elongated self-contained breathing apparatus (SCBA). The mounting bracket assembly comprises a base configured to be coupled to the vehicle seat and a foot having a first end coupled to the frame and extending away therefrom to a second end with a midsection therebetween. The foot has a first ramp that ramps upwardly from the second end to the midsection and a second ramp that ramps downwardly from the first end to the midsection. The mounting bracket assembly further comprises a cup positioned in the midsection. The cup is configured to receive a valve of the SCBA therein to prevent movement of the valve relative to the foot. The first ramp and the second ramp are configured to guide the valve towards the midsection and thereby assist a user in positioning the valve of the SCBA in the cup.

In certain embodiments, the cup has an opening comprising at least tow different shapes to thereby accommodate different configurations for the valve.

In certain embodiments, the cup is removable from the midsection and positionable therein in at least two positions. The cup has an opening that is asymmetrical such that in a first of the at least two positions the opening is configured to receive a first valve type as the valve therein and in a second of the at least two positions the opening is configured to receive a second valve type as the valve therein.

In certain embodiments, the cup is rotated 180-degrees between the at least two positions.

Another aspect according to the present disclosure generally relates to a mounting bracket assembly for a vehicle seat for releasably holding an elongated self-contained breathing apparatus (SCBA). The mounting bracket assembly comprises a base configured to be coupled to the vehicle seat; a frame movably coupled to the base; and a head pivotably coupled to the frame so as to move therewith relative to the base. The head is pivotable between a closed position to retain the SCBA to the vehicle seat and an open position in which the SCBA is removable from the vehicle seat. The mounting bracket assembly further comprises a latch engageable to lock the head in the closed position. The latch is coupled to the frame so as to move therewith relative to the base. The latch is operatively coupled such that moving the frame relative to the base causes the latch to disengage to thereby allow the head to pivot towards the open position.

In certain embodiments, the mounting bracket assembly further comprises a cable coupled to the latch and moving the frame relative to the base tensions the cable to disengage the latch.

In certain embodiments, the frame is movably coupled to the base such that the frame is moveable only non-orthogonally relative to the base.

In certain embodiments, the latch is disengaged by simultaneously moving the frame upwardly and towards the base.

In certain embodiments, the frame is moveable relative to the base between a first position and a second position and gravity forces the frame towards the first position. The latch is engaged when the frame is in the first position.

In certain embodiments, the mounting bracket assembly further comprises a first damper that resists movement of the frame towards the second position so as to prevent accidental disengagement of the latch.

In certain embodiments, the mounting bracket assembly further comprises a second damper that resists movement of the frame towards the first position to allow the latch to disengage before the frame moves away from the second position.

In certain embodiments, the foot is configured to be coupled to the frame in at least two positions so as to be adjustable relative thereto.

In certain embodiments, the mounting bracket assembly is coupled to a seat cushion, further including a release handle moveably coupled to the seat cushion, and further including a cable coupled to the release handle and to the latch, wherein moving the release handle relative to the seat cushion tensions the cable to disengage the latch.

It should be recognized that the different aspects described throughout this disclosure may be combined in different manners, including those than expressly disclosed in the provided examples, while still constituting an invention according to the present disclosure. Various other features, objects and advantages of the disclosure will be made apparent from the following description taken together with the drawings.

### BRIEF DESCRIPTION OF THE DRAWINGS

FIG. 1 is a perspective view of a self-contained breathing apparatus (SCBA) mounting bracket assembly according to the present disclosure.

FIG. 2 is a perspective view of the SCBA mounting bracket assembly of FIG. 1 with a SCBA installed therein.

FIG. 3 is a perspective view of a lock for the mounting bracket assembly of FIG. 1, which is shown in an engaged position.

FIG. 4 is a perspective view of a handle for the lock for the mounting bracket assembly from FIG. 3 with the lock in the engaged position.

FIG. 5 is a perspective view like FIG. 4, showing the lock in a disengaged position.

FIG. 6 is a front view of a clamping head for a mounting bracket assembly according to the present disclosure.

FIG. 7 is a sectional view taken through the clamping head of FIG. 6, showing a plunger lock for the clamping head.

FIG. 8 is an overhead view of the clamping head of FIG. 6.

FIG. 9 is a perspective view of a foot for a mounting bracket assembly according to the present disclosure.

FIG. 10 is a sectional side view through the foot from FIG. 9.

FIG. 11 is an overhead perspective view of the foot from FIG. 9.

FIG. 12 is a perspective view of a clamping assembly according to the present disclosure, shown in an open position.

FIG. 13 is an exploded view of a guide for the clamping assembly of FIG. 12, shown without a clamping head thereof.

FIG. 14 is a side view of the mounting bracket assembly of FIG. 9 with an SCBA installed therein.

FIG. 15 is a perspective view of a clamping assembly from the mounting bracket assembly of FIG. 14 shown in a closed position.

FIG. 16 is a side view of the mounting bracket assembly from FIG. 14 showing a frame in a first position relative to a base and the clamping assembly in the closed position.

FIG. 17 is a rear perspective view of the mounting bracket assembly of FIG. 16.

FIG. 18 is a close-up side view of the mounting bracket assembly showing the frame positioned relative to the base in the first position.

FIG. 19 is a close-up side view similar to the view of FIG. 18, showing the frame positioned relative to the base in a second position.

FIG. 20 is a side view of the clamping assembly in the closed position.

FIG. 21 is a side view similar to FIG. 20 showing the clamping assembly in an open position.

FIG. 22 is a rear perspective view of the mounting bracket assembly showing a section of a cable for releasing the clamping assembly.

FIG. 23 is a perspective view of another section of the cable from FIG. 22.

FIG. 24 is a rear perspective view of the mounting bracket assembly of FIG. 21.

FIG. 25 is a front view of the mounting bracket assembly of FIG. 21 with the clamping assembly in the closed position and with a clamping head removed.

FIG. 26 is a sectional side view through the mounting bracket assembly of FIG. 25, showing the clamping assembly in the open position.

FIG. 27 is a perspective rear view of the mounting bracket assembly of FIG. 25.

FIG. 28 is a perspective front view of another embodiment of a mounting bracket assembly according to the present disclosure.

FIG. 29 is a rear view of the mounting bracket assembly of FIG. 28.

FIG. 30 is a front view of another embodiment of a mounting bracket assembly according to the present disclosure.

FIG. 31 is a side view of the mounting bracket assembly of FIG. 30.

FIG. 32 is a front view of another embodiment of a mounting bracket assembly according to the present disclosure.

### DETAILED DESCRIPTION

As used herein, unless otherwise limited or defined, discussion of particular directions is provided by example only, with regard to particular embodiments or relevant illustrations. For example, discussion of “top,” “bottom,” “front,” “rear,” “left,” “right,” “horizontal,” “vertical,” “lateral,” and “longitudinal” features and/or relative motion, e.g., movement “up” and “down,” is generally intended as a description only of the orientation of such features relative to a reference frame of a particular example or illustration. Correspondingly, for example, a “top” feature may sometimes be disposed below a “bottom” feature (and so on), in some arrangements or embodiments. Additionally or alternatively, embodiments may be arranged in a different orientation such that “top” and “bottom” features are arranged horizontally relative to each other, for example in a “left-to-right” orientation.

Vehicles for emergency first responders (e.g., firetrucks or other rescue vehicles) often provide mechanisms for securing objects in transit. This includes objects such as air tanks, also referred to as cylinders, containers, etc., for self-contained breathing apparatuses (SCBA) used by firefighters once arriving on location. SCBA holders can be integrated into an opening or cavity in a seat back portion of a seat within the vehicle. Storing the SCBA in the seat back is intended to permit a user to still occupy that same seat, and to rapidly access and don the SCBA in response to an event. Applicable regulations typically require SCBAs to be restrained in a manner than ensures the SCBA remains secure during scenarios such as collisions, abrupt vehicle maneuvers, etc.

Holders as known in the art for securing SCBAs typically have a restraint that secures the SCBA until released by a user. For example, one type of holder uses belts to secure a tank within an elongated cavity in a seat (e.g., the Walkaway Bracket as produced by Ziamatic Corp.). Another example of a holder provides a restraint having a pivotable halo to hold the top of the tank in place, which is released by manually pulling on a handle positioned between the occupant's legs (e.g., the Halo Bracket by Seats Inc.). However, these and other known SCBA holders require manual intervention in securing and unsecuring the tanks with the holders. The present inventors have recognized that these manual mechanisms can be hard to reach, difficult to locate, and/or difficult to actuate or release the locking mechanism.

Accordingly, the present inventors have recognized that it is desirable to provide a releasable holder (also referred to as a mounting bracket assembly) for an object such as an SCBA that allows for non-manual intervention to at least unsecure the tank from the holder. In other words, there is an unmet need for a solution for releasing the SCBA without necessitating the user's hands, which may be occupied carrying other equipment, using a radio, grasping handles to help the user stand up, and/or be involved in other tasks such as synching SCBA backpack straps. This would allow the SCBA to be freely installed and uninstalled for use in a vehicle in a manner which is fast, convenient and efficient. It should be recognized that while the examples provided herein may focus on holding SCBAs in vehicles, the mounting bracket assemblies may also be used to hold SCBAs in other locations, coupled to other objects, and in other contexts. By way of example, the mounting bracket assemblies disclosed herein may be advantageously used to hold SCBAs in storage areas within a fire station (or a dive shop for SCUBA), such as mounting on a wall or within storage lockers. As such, for brevity, any references to “vehicles” shall be understood to include other contexts such as on-wall storage in buildings.

It is also desirable to provide a releasable mounting bracket assembly that is variously adjustable to accommodate different sizes and types of SCBAs. The differences in SCBA types include differences in height, diameter, and shape of the valve of the SCBA, which vary by manufacturer, country, and the like. In view of this, the present disclosure provides solutions for releasable mounting bracket assemblies that are adjustable between various lengths, diameters, and shapes. These solutions are, advantageously, adjustable by a user without the use of tools so that adjustment may be accomplished efficiently. This is a further advantage over adjustment mechanisms known in the art, which may be limited in adjustability and/or require tools for adjustment, as discussed further below.

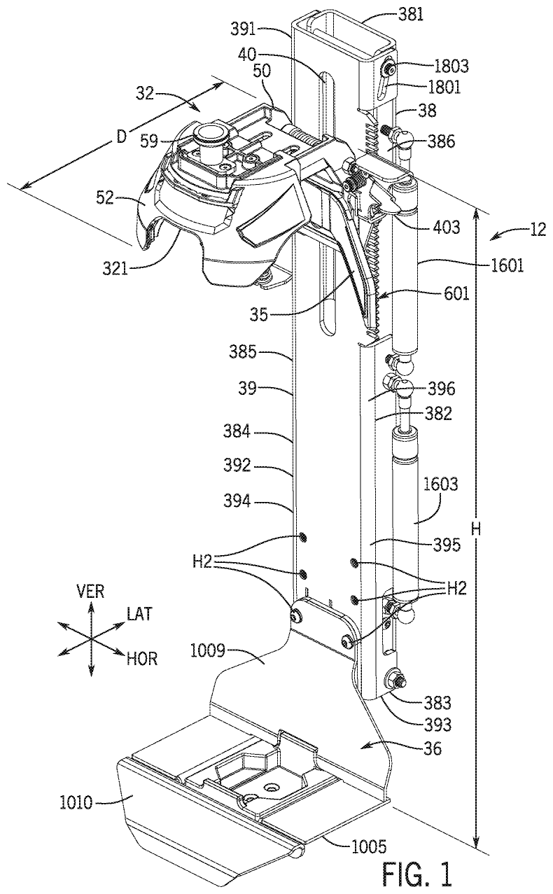

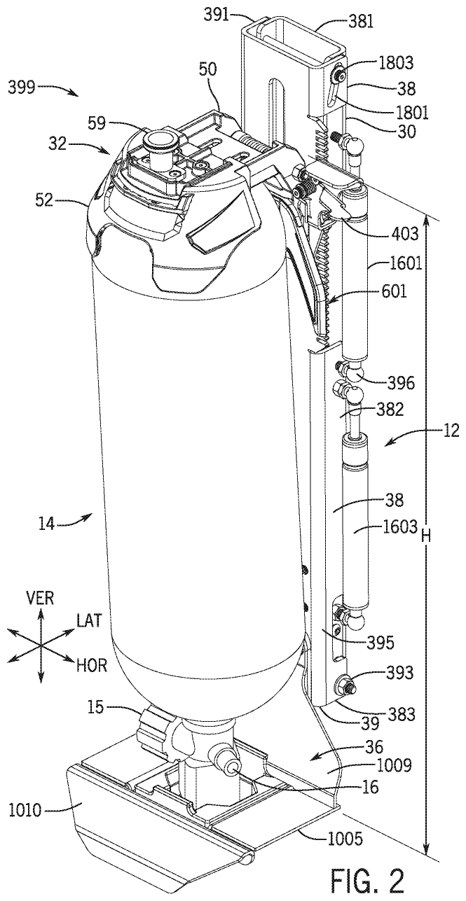

Referring to the drawings, FIGS. 1-2 illustrate a mounting bracket assembly 12 configured to releasably hold a self-contained breathing apparatus (SCBA) generally in the form of a cylindrical pressurized oxygen tank 14. Typically, the cylinder 14 is configured to be connected to a harness worn by a firefighter or the like in use. The mounting bracket assembly 12 is configured such that the cylinder 14 may be positioned at least partially in the seat of an emergency vehicle such that the user may still occupy the seat in front of the cylinder 14 in a conventional manner. Since the opening in the seat may be as conventionally known, this is not shown so as to avoid obscuring the mounting bracket assembly 12.

The cylinder 14 is secured to the seat by the mounting bracket assembly 12, with the cylinder 14 being held in an inverted position, as shown in FIG. 2. In this position, a regulator portion 15 of the cylinder 14 is supported at the bottom of the mounting bracket assembly 12, as discussed further below. A domed end of the cylinder 14 and the regulator portion 15 define opposite ends of the cylinder 14, here extending in the vertical direction VER when secured to the seat. The regulator portion 15 comprises a valve 16. It should be recognized that the mounting bracket assemblies 12 disclosed herein are advantageously configured to work with many different makes and models of SCBAs, as well as valves therefor, as discussed further below. For the sake of brevity, additional detail regarding these known SCBAs is not provided herein.

The mounting bracket assembly 12 is generally comprised of a back support assembly 30, a clamping head 32, a carriage 35 (FIG. 1), and a foot 36. The back support assembly 30 functions to anchor the mounting bracket assembly 12 to a support surface such as the rear portion of the seat of an emergency vehicle. The anchoring of the mounting bracket assembly 12 to the vehicle seat may be in a conventional manner, and is therefore not discussed further for the sake of brevity.

The back support assembly 30 is formed of a rectangular base 38 and a rectangular frame 39, which in certain embodiments are formed of rigid, extruded metallic constructions. The frame 39 is moveable relative to the base 38, specifically in the vertical direction VER and lateral direction LAT as discussed further below. The base 38 is stationary relative to the vehicle seat on which the SCBA mounting assembly 12 is installed, and may be coupled to the seat in a conventional manner (e.g., with fasteners such as bolts coupled to a metal frame within the seat). The base 38 spans between a top 381 and a bottom 383, between a front 384 and a rear 382, and between a left side 385 and a right side 386. As discussed above, the frame 39 is moveable relative to the base 38 and the vehicle seat on which the SCBA mounting assembly 12 is installed. The frame 39 spans between a top 391 and a bottom 393, between a front 392 and a rear 396, and between a right side 395 and a left side 394.

With continued reference to FIGS. 1-2, the back support assembly 30 normally has a length in the vertical dimension commensurate with the vehicle seat in which it is installed. However, the length may vary depending on the particular application. The frame 39 is formed with a first set of holes 42 that receive fasteners for securing the foot 36 to the frame 39, such as screws, or bolts. The foot 36 acts to adjustably support the inverted top or regulator portion 15 of the cylinder 14. The base 38 is configured to be securely coupled with the seat shroud of a vehicle seat in an emergency vehicle. Alternatively, the base 38 could be secured to a different support structure, such as for example, a wall. A clamping head 32 is configured to clamp down on the SCBA, specifically on the domed end of the cylinder 14 opposite the regulator portion 15. Specifically, the domed end of the cylinder 14 fills a cavity 321 inside the clamping head 32. The frame 39 further comprises vertical adjustment lever 403, as described further herein below.

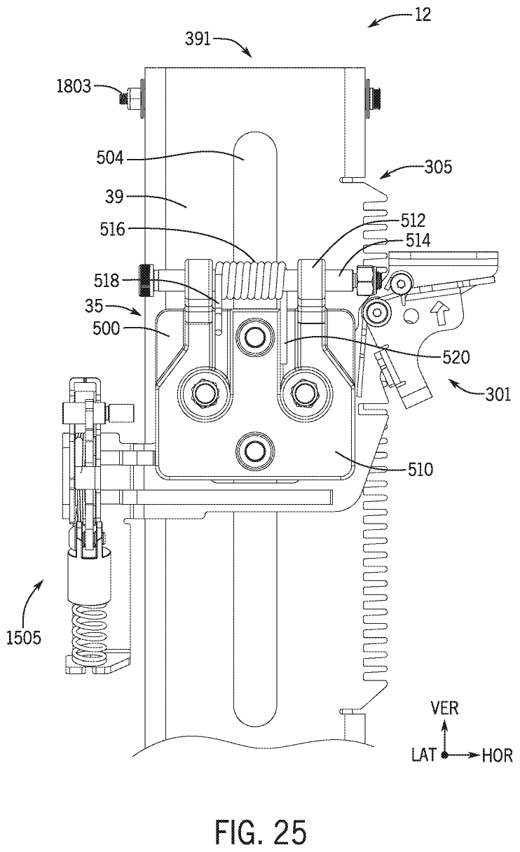

A carriage 35 is moveable relative to the frame 39, which as discussed above is moveable relative to the base 38. The carriage 35 and the clamping head 32, along with other components discussed further below, comprise a clamping assembly 399. The moveable frame 39 comprises an aperture 40, near to the top 391 of the moveable frame 39, in which the carriage 35 moves slides vertically to adjust the vertical position of clamping head 32 relative to the base 38. By way of example, bolts or another fasteners may extend through the back of the frame 39, via the aperture 40, and threadingly engage with the carriage 35 to constrain the carriage 35 to only moving vertically within the aperture 40. The carriage 35 allows a user to adjust the height H of the clamping head 32. Additional detail regarding the carriage 35 is provided below and shown in FIGS. 25-27.

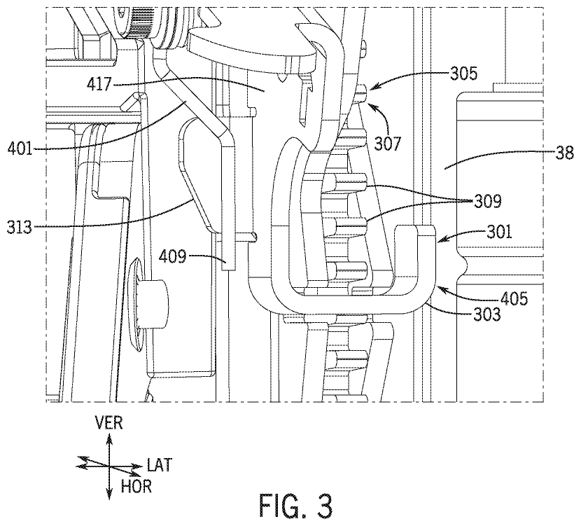

Referring to FIGS. 3-5, the mounting bracket assembly 12 and the clamping assembly 399 thereof comprises a lock 301 for securing the vertical position of carriage 35 relative to rectangular base 38. The lock 301 comprises a pawl 303 and a rack 305. The rack 305 is fixedly coupled with the base 38 and comprises teeth 309. The pawl 303 is a u-shaped end which is configured to engage with the teeth 309. The pawl 303 is integrally formed with a tab 313, a main body 417, and a handle 403 to form the lever 405, which is pivotably coupled with the carriage 35 to move therewith. The handle 403 is perpendicular to the main body 417 and is configured to receive a force from the user pivot the lever 405 to disengage the pawl 303 from the teeth 309, thereby unlocking the lock 301. The pawl 303 and the handle 403 define opposite ends of the lever 405 in the vertical plane. The handle 403 is pivotable within a plane that is substantially parallel to the back of the vehicle seat in which the SCBA mounting bracket assembly 12 is installed.

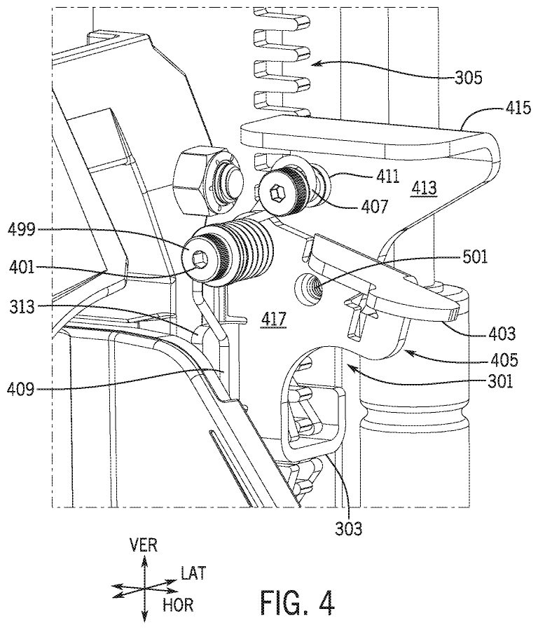

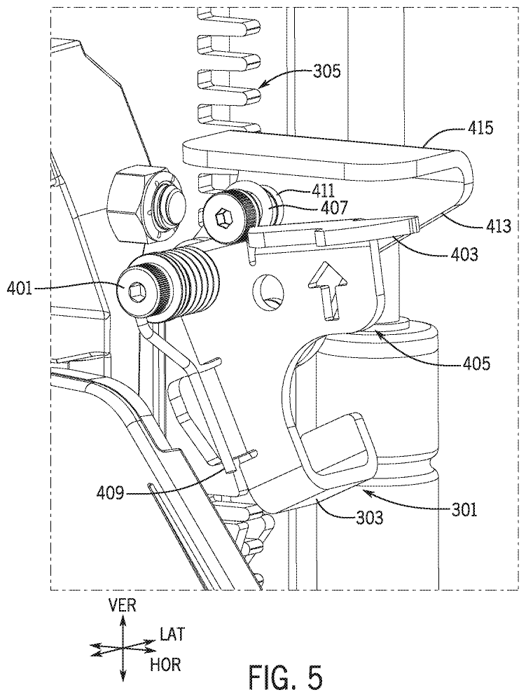

FIGS. 3 and 4 show the lock 301 in an engaged position, whereby the pawl 303 is engaged with the teeth 309 to thereby hold the carriage 35 stationary relative to the base 38. The handle 403 is configured to be pulled by a user in a plane substantially parallel to the back of the vehicle seat in an upward direction, which pivots the main body 417 about a fastener 499 pivotally coupling the handle 403 to the carriage 35. This in turn causes the pawl 303 to pivot out of engagement with the teeth 309 to unlock the lock 301. FIG. 5 shows the lock 301 in such a disengaged position. When the lock 301 is disengaged, the pawl 303 is not engaged with the teeth 309 and the carriage 35 is moveable in the vertical direction relative to the base 38 to adjust the height of the clamping head 32 to correspond to the height of the cylinder 14.

In certain embodiments, a spring 401 is present (here being coiled around the fastener 499) and is configured to bias the lock 301 towards the engaged position by providing a rotational force on the tab 313 of the lever 405. The tab 313 is perpendicular to the main body 417 in the lateral plane. The spring 401 extends from upper end 407 to lower end 409. The upper end 407 is statically coupled with a spring seat 411, which is integrally formed with a static member 413. The static member 413 has an upper tab 415 which is substantially parallel to the horizontal plane and substantially parallel to the handle 403 of the lever 405 when the handle 403 is pulled by a user such that lock 301 is disengaged, as is shown in FIG. 5. The lower end 409 of the spring 401 is configured to engage with the tab 313 of the lever 405 to resist movement of the lever 405.

As such, the spring 401 resists movement of the lever 405 in the plane that is substantially parallel to the back of the vehicle seat in which the SCBA mounting bracket assembly 12 is installed. In order to disengage lock 301, enough force must be applied to handle 403 to overcome the resisting force of spring 401. In this manner, spring 401 prevents accidental disengagement of the lock 301, allowing the carriage 35 to remain stationary relative to the base 38. In the orientation shown, it can be seen that a pair of holes 501 extending through the static member 413 and the main body 417 are coaxially aligned when the handle 403 is not compressed to permit adjustment. By way of non-limiting example, a pin or a threaded bolt (not shown for clarity) may be inserted through the holes 501, thereby preventing pivoting of the handle 403. The present inventors have provided these holes 501 as a lock-out to prevent further adjustment once the mounting bracket assembly 12 has been properly set for a given type of cylinder 14.

Through research and development, the present inventors have recognized that it is advantageous to configure a mounting bracket assembly to be easily adjustable in the vertical plane. Previously, these adjustments required the use of tools and were time-consuming. With the present invention, a user may adjust the vertical position of a clamping head, for instance to accommodate differing lengths of oxygen tanks, without the use of tools, making emergency operations safer and more efficient.

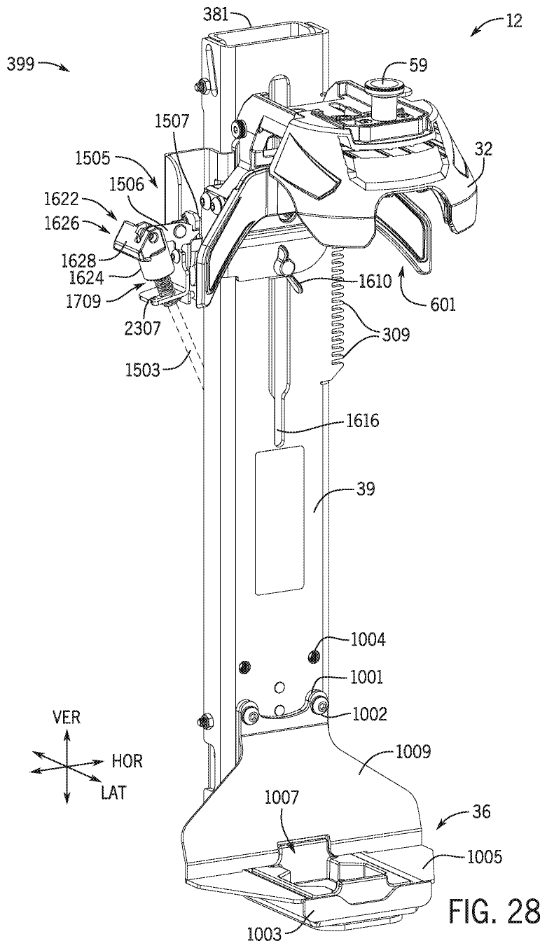

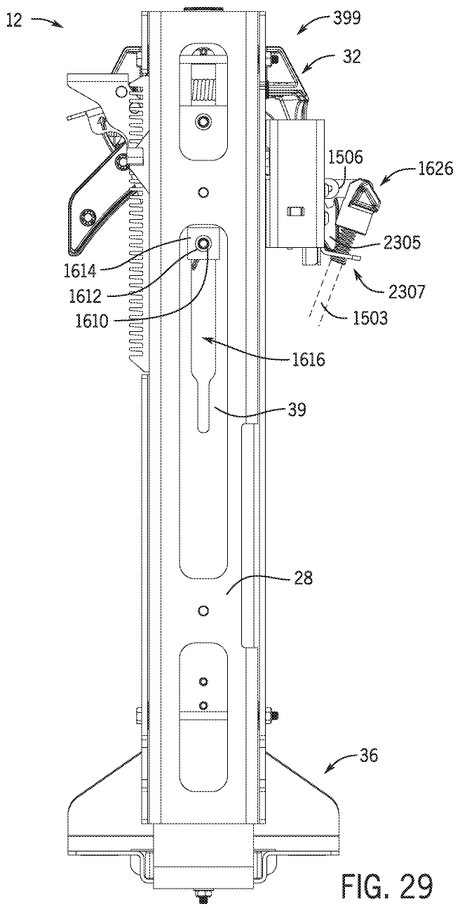

In certain embodiments, the system 12 is further configured such that once the height has been adjusted in the vertical plane, the carriage 35 can be further locked in position via tightening a manual fastener. By way of example, the system 12 of FIGS. 28-30 includes such manual locking functionality via a thumbscrew 1610 that extends through an opening in the carriage 35 and is threaded into an opening 1612 in a plate 1614 on an opposite side of the frame 39. The thumbscrew 1610 is slidable within a slot 1616 in the frame 39, allowing the carriage 35 to be moved vertically relative to the frame 39 in the manner described above. Once the carriage 35 is positioned as described, the thumbscrew 1610 may be tightened to thereby draw the plate 1614 against the back of the frame 39, effectively sandwiching the frame 39 between the plate 1614 and the carriage 35 to prevent relative movement therebetween. This added but optional feature prevents the carriage 35 from moving if the lever 405 is inadvertently bumped, for example in transit or while an operator is exiting or walking back a seat. If such accidental contact occurs while the manual fastener is in place, the carriage 35 will not move, and the lever 405 will automatically re-engage via the mechanisms discussed above, without any detrimental change to the system setup.

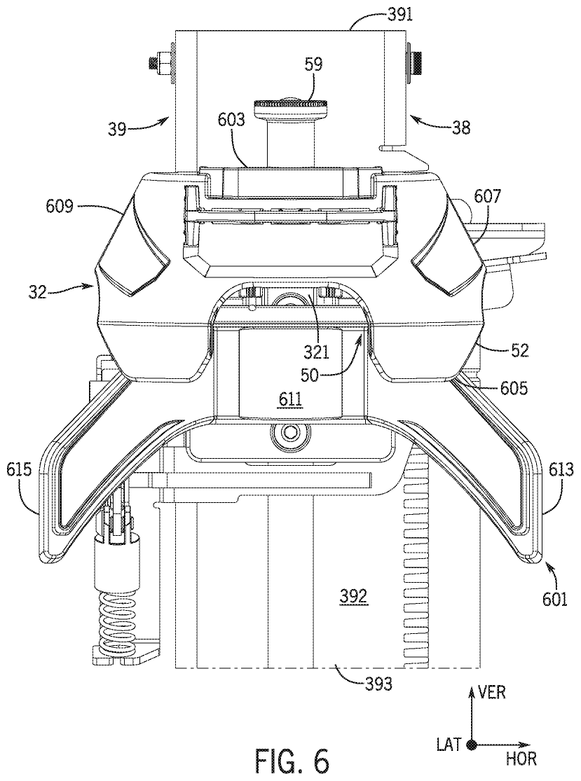

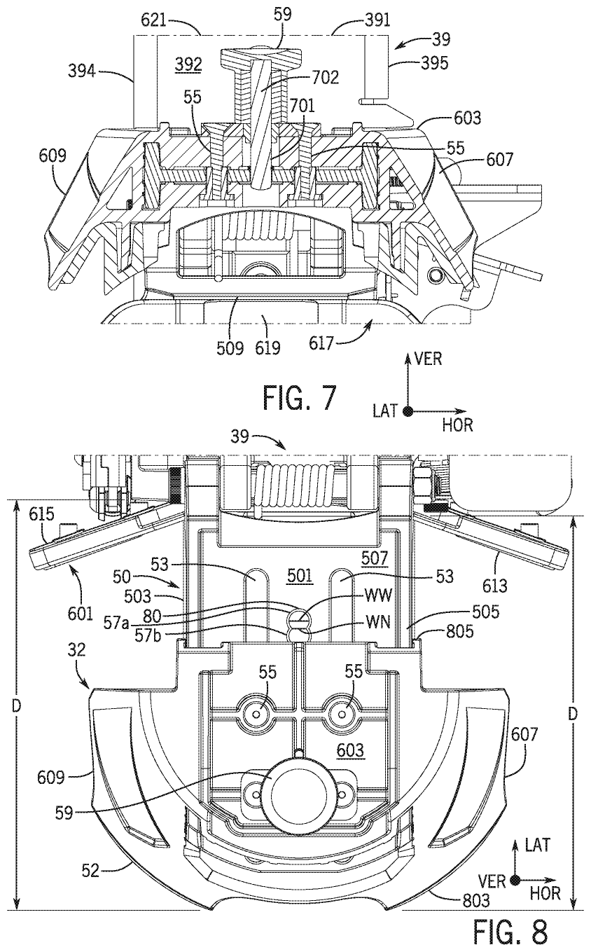

Referring now to FIGS. 6-8, description is provided for configurations of mounting bracket assemblies that are adjustable to accommodate different diameters of cylinders. The clamping head 32 serves to automatically and lockingly engage and disengage with the inverted, domed bottom end of the cylinder 14. The clamping head 32 comprises a cavity 321 which is configured to receive the inverted, domed bottom end of a cylinder 14. The clamping head 32 spans from a top 603 to a bottom 605, from a left side 609 to a right side 607, and from a front 803 to a rear 805. The clamping head 32 comprises a clamp 52 that engages with the inverted, domed bottom end of the tank 14. The clamping head 32 further comprises a funnel portion 601. The funnel portion 601 is comprised of a center 611 from which an integrally formed left arm 615 and right arm 613 extend. The funnel portion 601 functions to center a cylinder tank 14 in the cavity 321. The left arm 615 and the right arm 613 extend at broad angles relative to the lateral direction so as to more easily “catch” the cylinder 14 and guide the cylinder 14 towards the center 611 to be aligned with the clamp 52. By way of example, the left arm 516 and the right arm 613 may extend at greater than 35°, greater than 45°, greater than 60°, or other angles relative to the lateral direction LAT to provide improved funneling over designs presently known in the art. In certain configurations, the left arm 615 and the right arm 613 span a distance of greater than 5″, greater than 6″, greater than 7″, or other distances to provide automatic centering across a large range of starting cylinder positions, which from experimentation has proven very helpful for users.

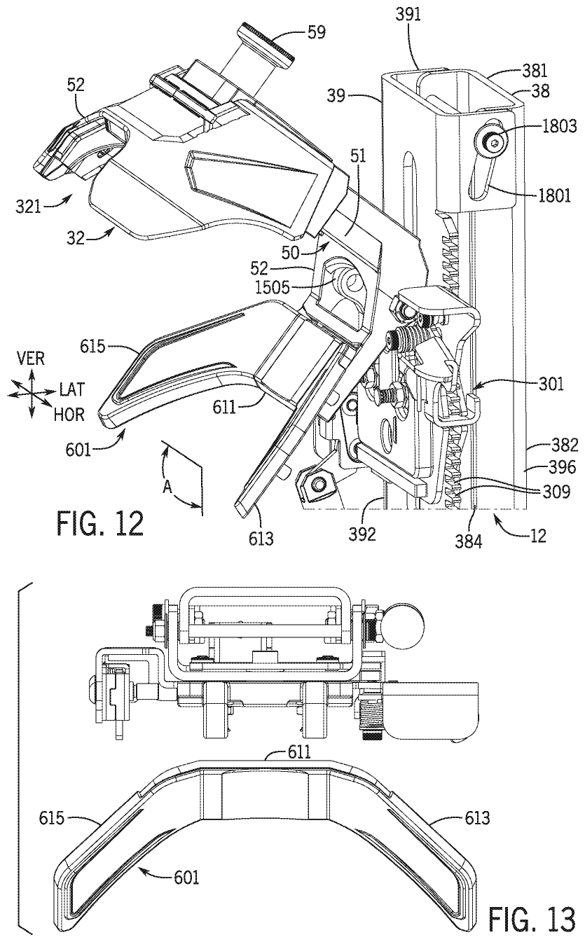

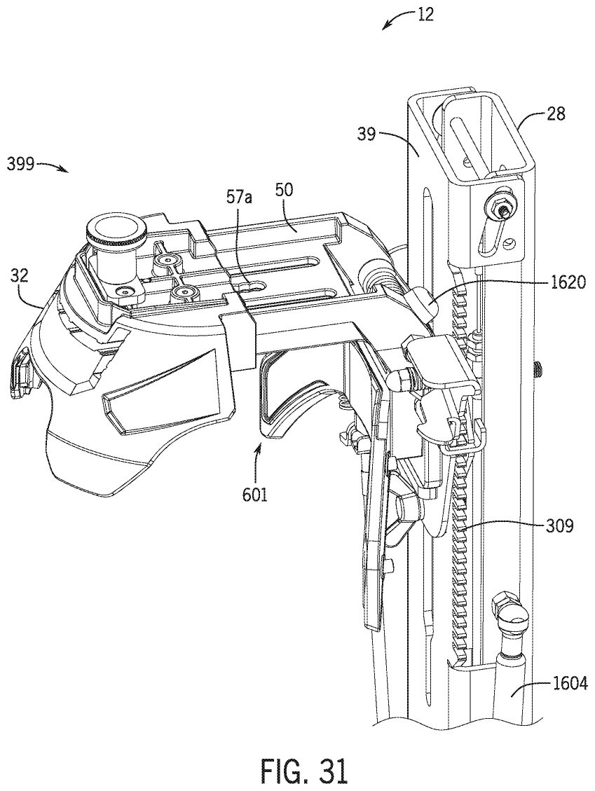

The clamping head 32 is movably coupled to a pivot arm 50. The pivot arm 50 is pivotally coupled with and extends away from the carriage 35 (see FIG. 1) to move vertically therewith. The pivot arm 50 extends away from the frame 39 in the lateral direction. The pivot arm 50 extends from a right side 505 to a left side 503 and a from a top 507 to a bottom 509. The pivot arm 50 extends substantially perpendicularly away from the frame 39 when the clamping assembly 399 is in the closed position as shown in FIGS. 6-8, and at a greater angle relative to the vertical direction VER when the clamping assembly 399 pivots upwardly into the open position as shown in FIG. 12. The pivot arm 50 may be similar to or the same as those of designs presently known in the art, including in the patents incorporated by reference herein above and in commercial products such as the SecureAll™ line produced by H.O. Bostrom. As such, for brevity, further detail regarding the pivot arm 50 and its pivotable coupling to the frame 39 is not provided herein. In certain embodiments, a bumper 1620 (see FIG. 31) is provided on the pivot arm 50 to provide cushioning between the pivot arm 50 and the frame 39 as the pivot arm 50 opens. The bumper 1620 may be of a type commercially available, for example being rubber, plastic, felt, cork, or an elastomeric material that is screwed, adhered, or otherwise attached to the pivot arm 50. The bumper 1620 may be alternatively provided on the frame 39. The bumper 1620 not only prevents a loud, harsh, and abrupt sound as the pivot arm 50 pivots open, but also provides for quiet, cushioned support when the pivot arm 50 is left in the open position (potentially with the vehicle being driven in this manner). The biasing mechanisms opening the pivot arm 50 maintain contact between the bumper 1620 and the frame 39.

With continued reference to FIGS. 6-8, the pivot arm 50 comprises channels 53. The clamping head 32 comprises holes. Threaded fasteners 55 pass through the holes of the clamping head 32 and the channels 53 of the pivot arm 50 to couple the pivot arm 50 to the clamping head 32. When coupled in this manner, the clamping head 32 can only move in the lateral direction relative to the pivot arm 50, as shown in FIG. 8. This lateral movement allows a user to adjust the depth D of the clamping head 32.

The pivot arm 50 further comprises a series of adjacent openings, of which openings 57a and 57b are currently visible but others are present below the clamping head 32. Unlike openings of devices presently known in the art, the openings 57a, 57b in the pivot arm 50 are configured such that they overlap so as to be open to each other. The adjacent openings 57a and 57b are exemplarily crescent shaped. The adjacent openings 57 comprise a perimeter 801. The adjacent openings have a wide width WW at the diameter of the circle formed by the adjacent openings and a narrow width WN at the point where the adjacent openings overlap. As will become apparent, the narrow widths WN prevent a pin 57 (discussed below) from freely sliding in the lateral direction LAT between openings 57a, 57b. However, the openings 57a, 57b may be substantially closer than configurations in which the opening are entirely discrete and separated from each other by solid material, thereby allowing finer-tuned adjustment of the clamping head 32.

The clamping head 32 further comprises a plunger lock 59. The plunger lock 59 is coupled to the clamping head 32 such that plunger lock 59 can only move in the vertical direction relative to the clamping head 32. The plunger lock 59 comprises pin 701 that is configured to selectively engage with (e.g., be positioned within) the adjacent openings 57 to laterally fix the clamping head 32 relative to the pivot arm 50. When the pin 701 is engaged with one of the openings 57a, 57b, the clamping head 32 is stationary relative to the pivot arm 50. When the plunger lock 59 is disengaged with the openings 57a, 57b, that is when a user has pulled the plunger lock 59 via a shaft 702 in the vertical direction such that the pin 701 disengages with the openings 57, the clamping head 32 is moveable in the lateral direction LAT with respect to pivot arm 50. The pin 701 and the shaft 702 are integrally formed with each other to form the plunger lock 59.

The plunger lock 59 further comprises a spring (for clarity, not shown), which biases the plunger lock 59 to the locked position wherein the plunger lock 59 is engaged within one of the openings 57a or 57b. Since spring-loaded plungers are commercially available, further detail regarding the spring is not provided herein for brevity. When the plunger lock 59 is released by a user, the plunger lock 59 returns to the locked position wherein the plunger lock 59 is engaged with the openings 57a or 57b. In this manner, by lifting and releasing the plunger lock 59, a user can lock and unlock the plunger lock 59. When the plunger lock 59 is unlocked, a user may adjust the clamping head 32 in the lateral direction relative to the pivot arm 50. By adjusting the lateral position of the clamping head 32 relative to the pivot arm 50, a user can adjust the mounting bracket assembly 12 to securely hold cylinders of differing diameters.

At least by including overlapping openings, the present invention improves on the prior art by allowing for finer adjustments of the position of the clamping head 32 relative to the pivot arm 50, as discussed above. This allows for a better fit of the clamp 52 over the cylinder 14 and increases the safety and efficacy of emergency operations. It should be recognized that the openings 57a, 57b need not be crescent or circular shaped to achieve the benefits disclosed herein. By way of example, these may instead be triangles, teardrop shaped, or other shapes.

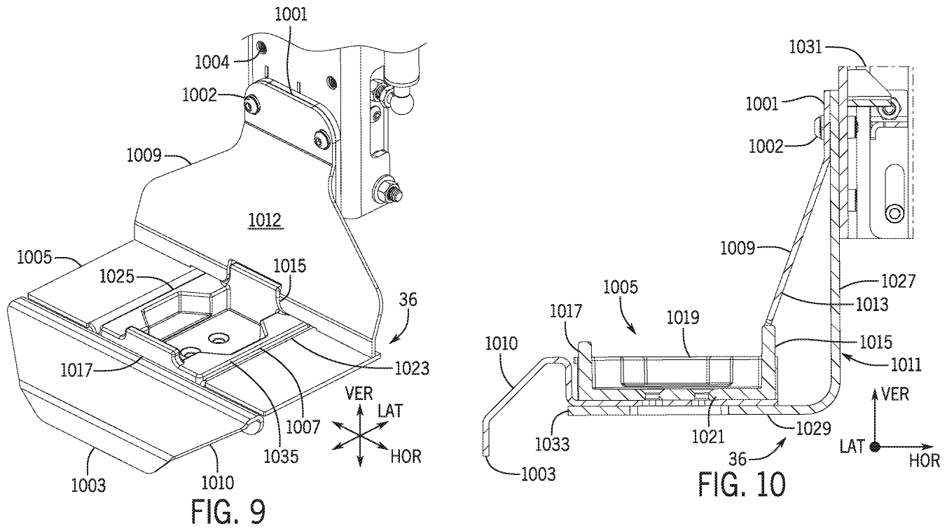

Referring to FIGS. 9-11, additional information is now provided relating foot ends of the mounting bracket assemblies according to the present disclosure. In the embodiment shown, the foot 36 comprises a first end 1001, a second end 1003, and a midsection 1005. The foot 36 is coupled to the frame 39 of the mounting bracket assembly 12 as described above near to the first end 1001 of the foot 36, in the present embodiment being adjustable via fasteners 1002 that extend through the openings in the foot 36 and are threaded into openings 1004 in the frame 39. Pairs of openings 1004 are provided at different vertical positions along the frame so as to provide a mechanism of coarse adjustment to accommodate for different heights of SCBA tanks to be supported by the foot 36. Once a particular system is set up for the type of SCBA tank used for a given operator, the foot 36 need not be moved again relative to the frame 39.

The first end 1001 comprises a first ramp 1009, which slopes downward from the first end 1001 to the midsection 1005. In the embodiment of FIGS. 9-11, the second end 1003 comprises a second ramp 1010, which slopes upward from the second end 1003 to the midsection 1005. The first ramp 1009 and the second ramp 1010 are configured to guide the regulator portion 15 and valve 16 of a cylinder 14 towards the midsection 1005. The present inventors have recognized that these ramps are especially advantageous in use as a user is backing into the mounting bracket assembly with the cylinder 14 on his or her back, which is cumbersome and provides limited or no visibility for alignment in at least the vertical and lateral directions. It should be recognized that the present disclosure contemplates other designs in which one or both of these ramps are omitted, whether being unnecessary, an unelected configuration option, and/or omitted to reduce the depth of the assembly, for example. By way of example, the embodiment of FIG. 28 shows a foot 36 in which the second end 1003 is substantially vertical rather than being ramped.

The midsection 1005 comprises a cup 1007, which sits in a cup cutout 1035 within the midsection 1005 (allowing replacement or the cup 1007 for different configurations, for service, and/or the like). The cup 1007 extends from a top 1019 to a bottom 1021, from a front 1017 to a back 1015, and from a right side 1023 to a left side 1025. The cup 1007 is configured to receive the regulator portion 15, including the valve 16, of the cylinder 14, to laterally and horizontally retain the cylinder 14 relative to the mounting bracket assembly. When the regulator portion 15 of the cylinder 14 is engaged with the cup 1007, the cylinder 14 is stationary relative to the foot 36. Thereby, the first ramp 1009 and the second ramp 1010 are configured to assist a user in positioning the valve 16 of a SCBA in the cup 1007.

The cup 1007 is typically comprised of a plastic material, e.g., Thermoplastic Polyurethane or Delrin. The foot 36 is reinforced by the foot support 1011, which conforms along the rear and bottom edges of the foot 36. The foot support 1011 is typically comprised of a metal material, e.g., steel. The foot support 1011 comprises a first portion 1027, which is substantially vertical, integrally formed with a second portion 1029, which is substantially horizontal. The foot support 1011 spans from first end 1031 at the top of vertical first portion 1027 to second end 1033 at the end of horizontal second portion 1029. Foot support 1011 does not extend as far in the horizontal direction as second ramp 1010.

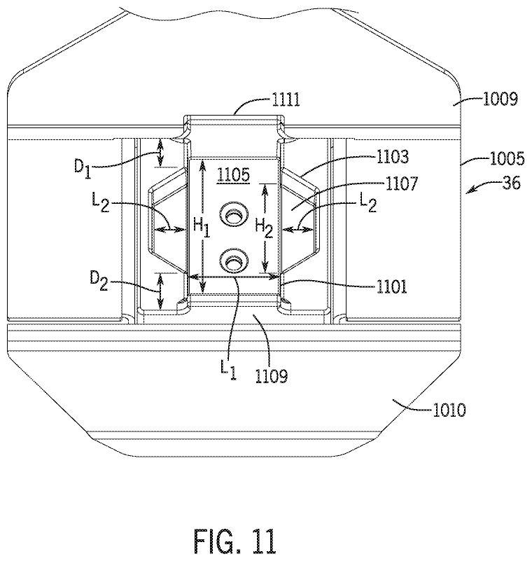

Different brands and types of cylinders 14 have differing sizes and shapes of regulator portions 15 and valves 16. In order to accommodate different brands and types of cylinders 14, the present inventors have recognized that it is advantageous to have a cup 1007 capable of receiving and securely holding different regulator portions 15 and valves 16. To that end, the cup 1007 is configured such that the opening of the cup 1007 comprises at least two different shapes, and also different orientations thereof. In the example shown in FIG. 11, the shapes are a rectangle, shown by a rectangular opening 1101, and an octagon, shown by octagonal opening 1103. The rectangular opening 1101 extends to a length L1 and a height H1 and has a lower surface 1105. The octagonal opening 1103 extends to a height H2 and has a length of L2 (in addition to the length L1 of the rectangular opening 1101) and has a lower surface 1107 (which in this embodiment is vertically above the lower surface 1105 of the rectangular opening 1101). The rectangular opening 1101 comprises raised tabs 1109 and 1111. Further to this end, the cup 1007 is configured to be positionable within at least two positions and removable from the cup cutout 1035 to accommodate differing shapes of regulator portions 15.

In certain examples, the cup 1007 is configured to be removable, rotatable 180 (and/or 90 or other) degrees, and re-installable to accommodate regulator portions 15 and valves 16 of varying shapes. The distance between the rectangular opening 1101 and the hexagonal opening 1103 on the upper portion of the cup 1007, D1, is different than the distance between the rectangular opening 1101 and the hexagonal opening 1103 on the bottom portion of the cup 1007, D2. These distances may be reversed when the cup 1007 is removed, rotated 180 degrees, and reinstalled for use.

In certain embodiments, the cup 1007 has an opening that is asymmetrical such that in a first of at least two positions the opening of the cup 1007 is configured to receive a valve 16 of a first valve type as the valve 16 therein. In a second of at least two positions the opening of the cup 1007 is configured to receive a valve 16 of a second valve type as the second valve 16 therein. In the example shown in FIG. 11, the opening of the cup 1007 is asymmetrical such that the opening of the cup 1007 may receive a valve 16 of a substantially rectangular shape in rectangular opening 1101 and also may receive a valve 16 of a substantially octagonal shape in octagonal opening 1103. The openings in the cup 1007 may also or alternatively be positioned off-centered so as to be different distances from the raised tab 1109 in either orientation. In this manner, the cup 1007 offers universal acceptance of many different types of conventional valves, including those of Scott/Draeger, MSA G1, and MSA M7 (the cup 1007 being flipped 180 degrees as compared to the MSA G1).

Referring to FIGS. 12-13, additional detail is now provided for an improved mechanism for lock and releasing a cylinder 14 within a mounting bracket assembly according to the present disclosure. As discussed above, a clamping head 32 comprises a funnel portion 601 for installation of a cylinder 14 on a mounting bracket assembly 12 (see FIG. 2). The funnel portion 601 is configured to receive a cylinder 14 and guide the cylinder 14 to the center of the cavity 321 of the clamping head 32. The funnel portion 601 functions to center an upper portion of an inverted cylinder 14 during ingress and egress relative to the mounting bracket assembly 12. The guide 1201 is a bifurcated or forked construction provided with a center section 611 integral with a left arm 615 and a right arm 613.

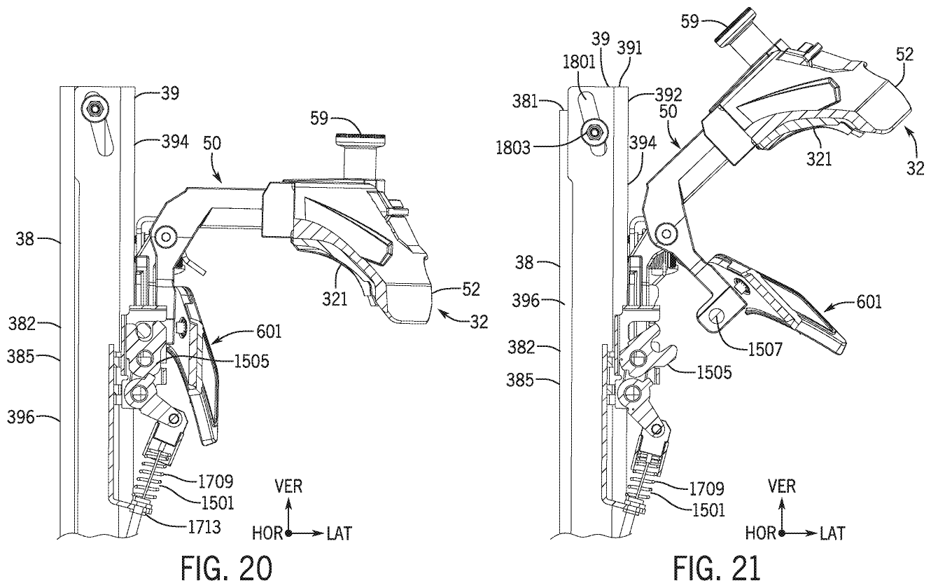

The clamping head 32 is coupled to the pivot arm 50 as described above. The pivot arm 50 comprises horizontal section 51 and vertical section 52, which are integrally formed or otherwise permanently coupled together. When the clamping head 32 is closed on the domed end of a cylinder 14, the angle A between the horizontal section 51 and the vertical frame 39 is 90 degrees. When the clamping head 32 is open and not engaged with the domed end of a cylinder 14, as is shown in FIG. 12, the angle A between the horizontal section 51 and the vertical frame 39 is greater than 90 degrees. The horizontal section 51 and the vertical section 52 are always perpendicular to each other. The horizontal section 51 and the vertical section 52 are so named for ease of understanding; it is to be understood that when the clamping head 32 is in the open position neither the horizontal section 51 nor the vertical section 52 are in the horizontal or vertical planes, respectively. The mounting bracket assembly 12 further comprises a latch 1505 that releasably locks the clamping head 32 in the closed position. The latch 1505 functions as described herein below to secure the clamping head 32 in the closed position over the domed end of a cylinder 14. The latch 1505 may be of a type presently known in the art, such as those in the patents incorporated by reference above, or in commercially available offering such as a single stage mini rotary lock commercially available from the Eastern Company of Cleveland, Ohio. As is well known, the latch 1505 includes a rotary jaw biased by a torsion spring away from a latched position towards an unlatched position, and a rotary pawl that is biased by the same or a separate torsion coil spring away from a jaw releasing position to a jaw retaining position. The latch further comprises a pin 1507 configured to removably latch with the rotary jaw. The latch rotates around the horizontal axis as is shown in FIGS. 20-21. Through research and development, the present inventors have recognized that a reliable, efficient way to release a SCBA cylinder 14 from the clamping head 32 is necessary to increase the efficiency and safety of emergency operations. By providing force against the moveable frame 39 in the plane of permitted movement as described above, emergency operators can disengage SCBA cylinders 14 from clamping heads 32 in a reliable and efficient way. Additionally, emergency operators can provide the required force against the frame 39 without the use of their hands to pull a handle or the like as is known in the prior art. This hands-free release of the cylinder 14 from the clamping head 32 increases the efficiency of emergency operations and allows emergency operators to egress from vehicle seats in a reliable and efficient manner.

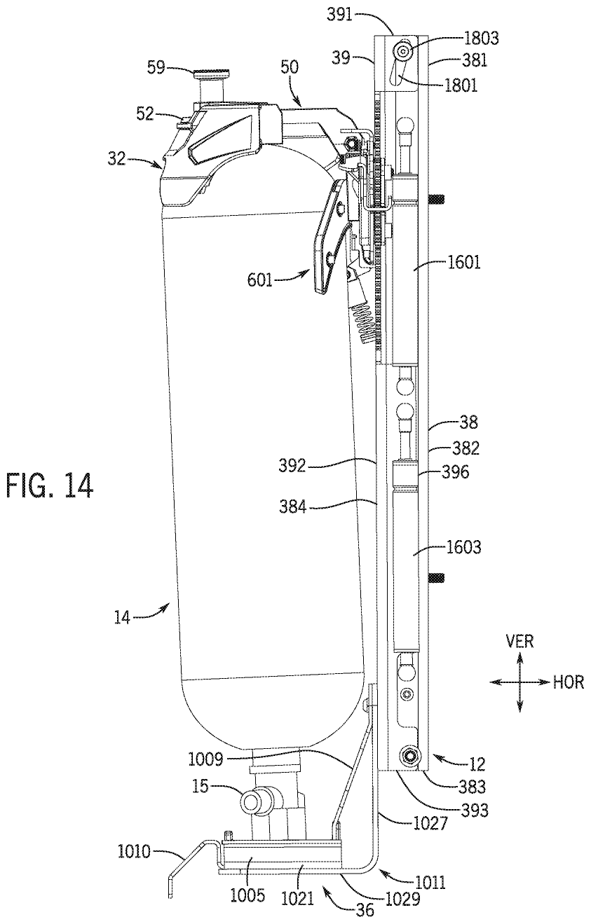

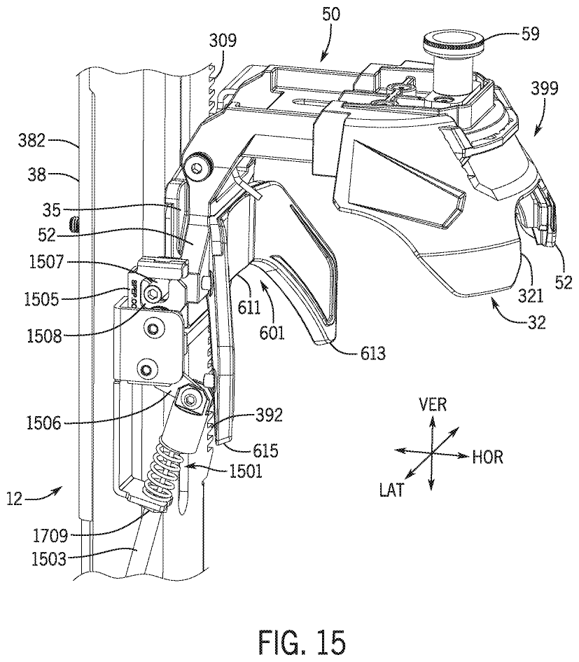

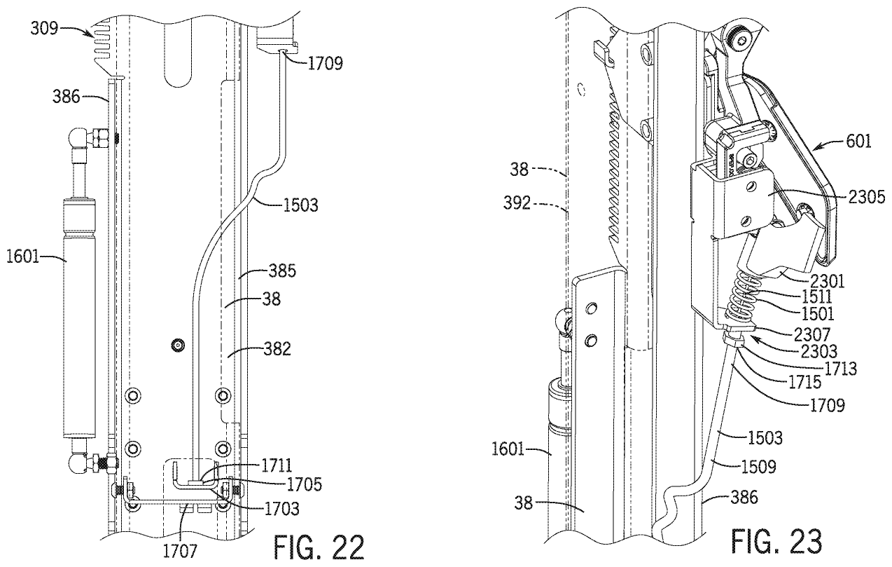

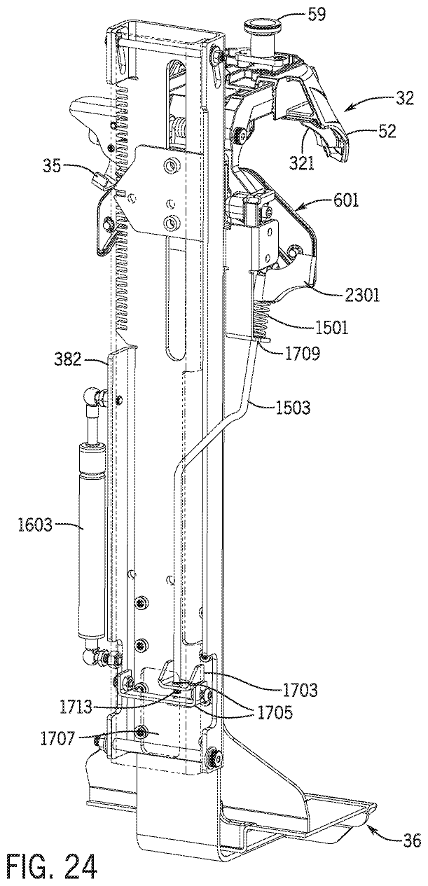

FIGS. 14-24 show a mounting bracket assembly 12 for a vehicle seat configured to hold an elongated SCBA cylinder 14, which may have features such as those described above. The mounting bracket assembly 12 comprises a base 38 configured to be coupled to the vehicle seat, as discussed above, as well as a frame 39 movably coupled to the base 38 such that the frame 39 is moveable relative to the base 38. The mounting bracket assembly 12 further comprises a clamping head 32 configured to removably and lockingly engage with the domed end of the cylinder 14 such that the cylinder 14 is stationary relative to the base 38. The clamping head 32 is coupled to the frame 39 so as to move therewith relative to the base 38. The clamping head 32 comprises a latch 1505. The latch 1505 is configured to be engageable to lock the clamping head 32 in the closed position. The latch 1505 is coupled to the frame 39 so as to move therewith relative to the base 38. As discussed above, the latch 1505 may be of a type presently known in the art. However, through experimentation and development, the present inventors developed new systems and mechanisms for which a user may unlock the clamping head 32 to provide advantages over systems presently known in the art.

A cable 1503 is coupled at one end to the latch 1505, specifically in such a manner that when the cable 1503 is tensioned, a downward force is provided on a lever arm 1506 of the latch 1505, causing a catch 1508 to disengage and release a latch pin 1507 attached to the pivoting vertical section 52 of the clamping head mechanism 399 therefrom. When the latch pin 1507 is released from the catch 1508, the vertical section 52 pivots away from the carriage 35 via a spring (not visible) and into the open position. As discussed above, the latch 1505 (including the lever arm 1506, catch 1508, and latch pin 1507) may be as conventionally known and thus, for brevity, is not discussed further herein.

In this manner, releasing the latch 1505 thereby releases the clamping head 32 from the domed end of the SCBA cylinder 14. However, the cable 1503 is not coupled at an opposing end in a manner known in the art. Rather, the cable 1503 is configured such that moving the frame 39 relative to the base 38 tensions the cable 1503, thereby unlatching the latch 1505 and releasing the clamping head 32 from the domed end of the SCBA cylinder 14.

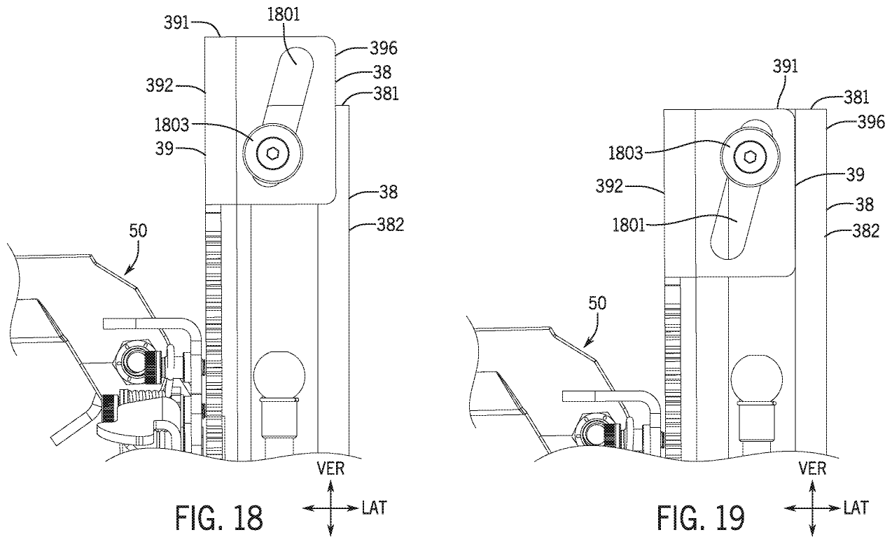

The cable 1503 comprises inner cable 1511 and outer sleeve 1509, such that outer sleeve 1509 completely surrounds the inner cable 1511 to protect the inner cable 1511 from wear and tear during use of the mounting assembly 12. The frame 39 is coupled at the top to the base 38 via channels 1801 in opposing sides of the frame 39, and at the bottom via channels 1802 in opposing sides of the base 38. A threaded fastener 1803 passes through the channel 1801 to couple the frame 39 to the base 38. The channel 1801 restricts the top 391 of the frame 39 to a single plane of movement relative to the base 38, which extends vertically and laterally. The direction of movement that the channel 1801 permits the fastener 1803 to move therein is non-orthogonal relative to the base 38. In short, the frame 39 is moveable from a first position as shown in FIG. 19 simultaneously upwardly and towards the base 38 to a second position as shown in FIG. 18. A similar fastener 1803 also extends through the frame 39 near the bottom 393 thereof and through the channel 1802 in the base 38. In this case the channel 1802 extends only in the vertical direction, thereby limiting movement of the bottom 393 of the frame 38 to only the vertical direction relative to the base 38 (as well as some rotation about the fastener 1803 from non-orthogonal movement at the top 391, as discussed above).

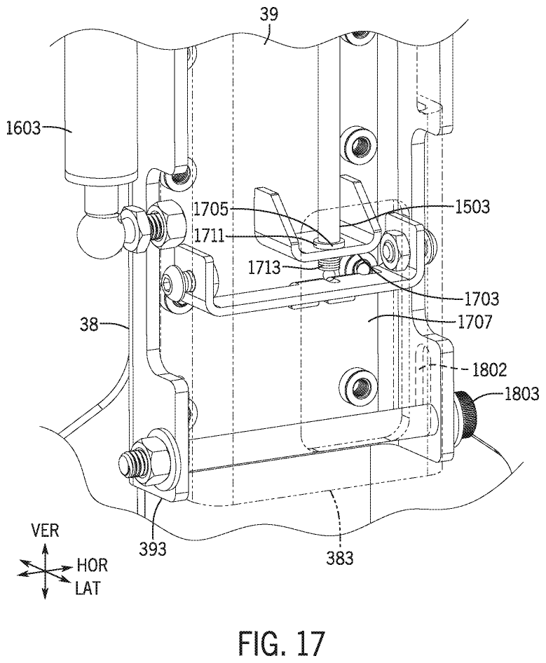

Referring to FIGS. 17 and 22-24, the cable 1503 is routed from the latch 1505 to an opening 1707. The cable 1503 spans from an upper end 1709 to a ball end 1705, through a sleeve 1509 that extends therebetween. The sleeve 1509 of the cable 1503 is held securely by a u-shaped bracket 1703 that is coupled to the frame 39 to be moveable therewith, here via threads as discussed below. The ball end 1705 is coupled to the base 38 to remain fixed therewith, for example via another bracket, a fastener, or other mechanisms known in the art. When the frame 39 moves vertically relative to the base 38, the u-shaped bracket 1703 causes the sleeve 1509 to move therewith. However, because the ball end 1705 of the cable 1503 remains fixed to the base 38, this movement of the sleeve 1509 tensions the cable 1503 similar to a hand brake on a bicycle. The ball end 1705 and the sleeve 1509 of the cable 1503 are accessible to a user through opening 1707, which allows the user to adjust the tension on cable 1503 by rotating an adjustable nut 1711 coupling that retains the axial position of the sleeve 1509 relative to the u-shaped bracket 1703. Rotating the nut 1711 in a first direction releases tension on the cable 1503, and vice versa.

The upper end 1709 of cable 1503 pulls on latch mechanism 2301 when the cable 1503 is tensioned such that the latch mechanism 2301 opens the latch 1505 as described above. The upper end 1709 of the cable 1503 also comprises an adjustable nut 1711 to adjust the tension on the cable 1503. Adjustable nut 1711 engages with a threaded portion 1713 of the outer sleeve 1509 of the cable 1503. The cable 1503 passes through a bracket 2303. The bracket 2303 comprises a first portion 2305 which is coupled to the frame 39 integrally formed with a second portion 2307 through which the cable 1503 passes and which supports the spring 1501 and the adjustable nut 1711.

It should be recognized that when no outside force is applied to frame 39, gravity holds frame 39 in a first position. When force is applied to the frame 39 in the direction of permitted movement by channel 1801, the frame 39 moves to a second position. When the frame 39 is in the first position, as is shown in FIG. 19, the latch 1505 is engaged and the clamping head 32 is clamped over the domed end of the SCBA cylinder 14 in a first clamping head position such that SCBA cylinder 14 is stationary relative to the mounting bracket assembly 12. The first, closed clamping head position is shown in FIG. 20 When the frame 39 moves relative to the base 38 to the second position, as is shown in FIG. 18, the cable 1503 is tensioned in the manner described above. When the cable 1503 is tensioned, the latch 1505 releases, and the clamping head 32 releases from the domed end of the SCBA cylinder 14 to a second clamping head position in which clamping head 32 does not restrict the movement of the SCBA cylinder 14 relative to the mounting bracket assembly 12. The second, open clamping head position is shown in FIG. 21. It should further be recognized that this advantageously provides user with a simple, hands-free mechanism for selectively releasing the clamping head 32 at will.

In certain embodiments, such as shown in FIGS. 28-30, the system 12 further includes a mechanism for manually releasing the clamping head 32 despite also being configured for hands-free releasing in the manner described herein. As discussed above, the clamping head 32 may be released by tensioning the cable 1503, which causes rotation of the lever arm 1506 and releasing of the latch 1505. Rather than pulling the cable 1503, the system 12 also permits a user to manually rotate the lever arm 1506 to the same effect, particularly by pressing on a button 1622 coupled to the lever arm 1506. The button 1622 may be integrally formed with or rigidly coupled to the lever arm 1506. In other embodiments, such as shown in FIG. 28, the button 1622 may be formed with or coupled to the upper end 1709 of cable 1503 (shown here to be a cap 1624 formed with or around the cable 1503 as a mechanism for pivotally coupling to the lever arm 1506). The button 1622 provides a sizeable, relatively flat surface 1626 with which the user may apply a downward force in an ergonomic and comfortable manner, rotating the lever arm 1506 and unlocking the latch 1505 as discussed above. Other configurations are contemplated. Likewise, the length of the lever arm 1506 and/or of the button 1622 may be varied to optimize the leverage and thus the effort required by a user in manually actuating the latch 1505. It should be recognized that the button 1622 may be used with or without a hands-free release mechanism for the clamping head 32.

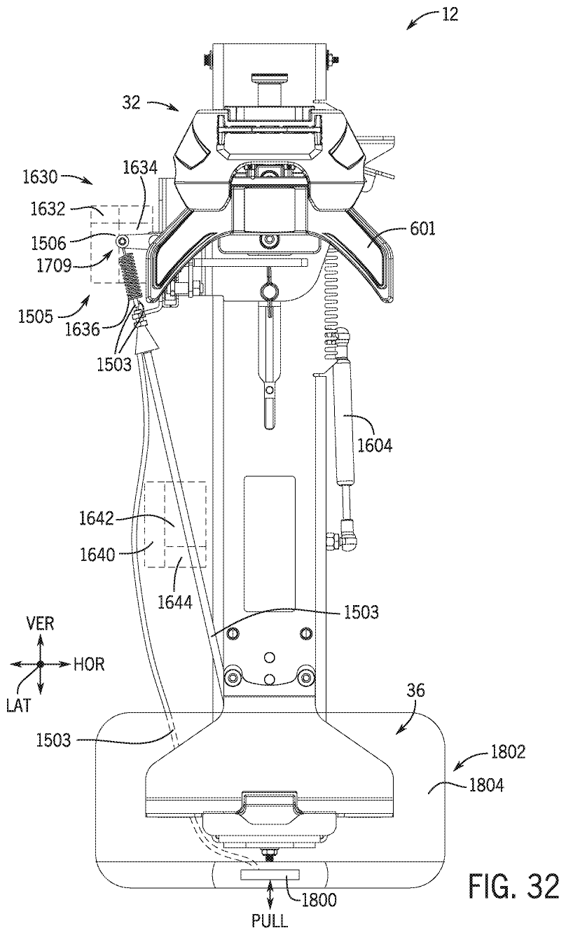

In further embodiments, as shown in FIG. 32, an electronic lock-out device 1630 may be provided to selectively prevent the clamping head 32 from releasing, whether via hands-free motions or manual buttons discussed above. The present inventors have recognized that in certain regions, it is advantageous or even required for a SCBA tank securement system to remain locked unless the vehicle is in a stable condition, for example being in park. For some securement systems known in the art (e.g., the SecureAll™ Electric by H.O. Bostrom) include an electronic lock-out device 1630 that prevents the clamping head 32 from unlocking when latched. The electronic lock-out device 1630 has a controller 1632 that determines or receives a signal corresponding to whether the vehicle is in park, for example, which may otherwise correspond to the engine being off or other parameters. When the controller 1632 has determined that the vehicle is in a safe condition, such as being in park, it controls a solenoid 1634 to retract (as shown in FIG. 32, laterally) a bolt 1636 that otherwise extends in proximity to the lever arm 1506 within the latch 1505 for releasing the clamping head 32. In the example shown, the bolt 1636 when extended is positioned directly below the lever arm 1506, thereby providing interference to prevent the lever arm 1506 from rotating. When the bolt 1636 is retracted, the lever arm 1506 is free to rotate at will in the manner described above. In this manner, the electronic lock-out device 1630 does not release the clamping head 32, but controls whether the clamping head 32 may be released by other mechanisms.

In yet further embodiments, the latch 1505 may be operatively coupled to an electronic actuator 1640, whether as a device with a solenoid 1642 that tensions the cable 1503 at the request of a user (e.g., similar to an electronic button controlled trunk release for automobiles), or that acts via other mechanisms. This electronic actuator 1640 may still be limited by an electronic lock-out device 1630 such as discussed above. Alternatively, the electronic actuator 1640 may have a controller 1644 that determines the status of the vehicle, as discussed above, and only permits operation of the solenoid 1642 to electronically actuator the latch 1505 when the vehicle is considered to be in a safe condition. It should be recognized that other configurations and locations for the electronic actuator 1640, and likewise the electronic lock-out device 1630, are contemplated, including rotating and/or preventing rotation of a latch rather than utilizing a cable 1503. Since electronic locks and lock-out devices are commercially available, further discussion is not provided herein for the sake of brevity.

As with other features disclosed herein, it should be recognized that this electronic lock-out device 1630 may be present with many different configurations according the present disclosure (e.g., with single or double acting dampeners, ramped or unramped feet, clamping heads that are adjustable in vertical and/or lateral directions, etc.). In each case, for the sake of brevity, it should be understood that these features may be interchangeable with different designs without expressly showing and describing every combination of such features.

In yet further embodiments, such as shown in FIG. 32, the latch 1505 may also or alternatively be released by a release handle 1800. In the embodiment shown, the mounting bracket assembly 12 is moveably coupled to a front 1804 of a seat cushion 1802 (shown as a sectional cutaway for clarity), for example in the manner disclosed in U.S. Pat. No. 8,469,324. The release handle 1800 may be moveable relative to the seat cushion 1802 via pivoting, moving in the lateral direction, moving in the vertical direction, and/or moving in the horizontal direction, by way of example. The release handle 1800 is coupled to a cable 1503, which may be the same as the cables 1503 discussed above as being coupled to other release handles or hands-free assemblies (e.g., bifurcating and/or being tied together), a separate cable 1503 operating in parallel thereto, or a lone cable 1503. When the release handle 1800 is moved relative to the seat cushion, the cable 1503 is tensioned, the latch 1505 releases, and the clamping head 32 releases from the domed end of the SCBA cylinder 14 to a second clamping head position in which clamping head 32 does not restrict the movement of the SCBA cylinder 14 relative to the mounting bracket assembly 12. As discussed above, the release handle 1800 may be provided as a redundant mechanism for releasing the clamping head 32, or as a sole mechanism for releasing the clamping head. Likewise, the present disclosure contemplates embodiments in which the release handle 1800 is provided in conjunction with other features disclosed herein, such as those to adjust for the height and/or diameter of the SCBA, the type of SCBA foot, the height of the valve foot supporting the SCBA from below, electronic lockouts, etc.

Returning to FIGS. 17 and 22-24, the mounting bracket assembly 12 is further configured to accept and lock-in a cylinder 14 by taking opposite steps to those discussed above. In short, when the clamping head 32 is in the open position, the funnel portion 601 centers the cylinder 14, which pivots the pivot arm 50 toward the frame 39 in the lateral direction until the latch 1505 re-engages to lock the cylinder 14 in position. The presently disclosed embodiments provide that this latching does not occur unless the cylinder 14 is substantially vertical, which is advantageous over systems presently known in the art. For certain models known in the art (e.g., similar to the SmartDock by IMMI), if the cylinder is not exactly vertical when locked into position, the cylinder can bind and not release when lock mechanism is later disengaged. This is avoided by the presently disclosed designs at least in part by ensuring vertical alignment of the cylinder upon locking in the first place.

Additional detail regarding the carriage 35 is now provided with reference to FIGS. 25-27, in which the carriage 35 is coupled to the pivoting arm 50 and the clamping head 32 (see e.g. FIG. 12) discussed above (which are removed here for clarity). The carriage 35 includes a front plate 500 and a back plate 502 that together sandwich the frame 39. A vertical slot 504 extends through the frame 39, through which fasteners 506 extend for coupling the front plate 500 to the black plate 502. In the embodiment shown, the fasteners 506 specifically extend through bushings, for example made of nylon, within the slot 504 to provide clearance in the lateral direction LAT and to ensure smooth translation of the carriage 35 relative to the frame 39. In the embodiment shown, the pawl 303 of the lock 301 discussed above also engages within a slot 508 in the back plate 502 (in addition to the rack 305) for further support when in the locked position.

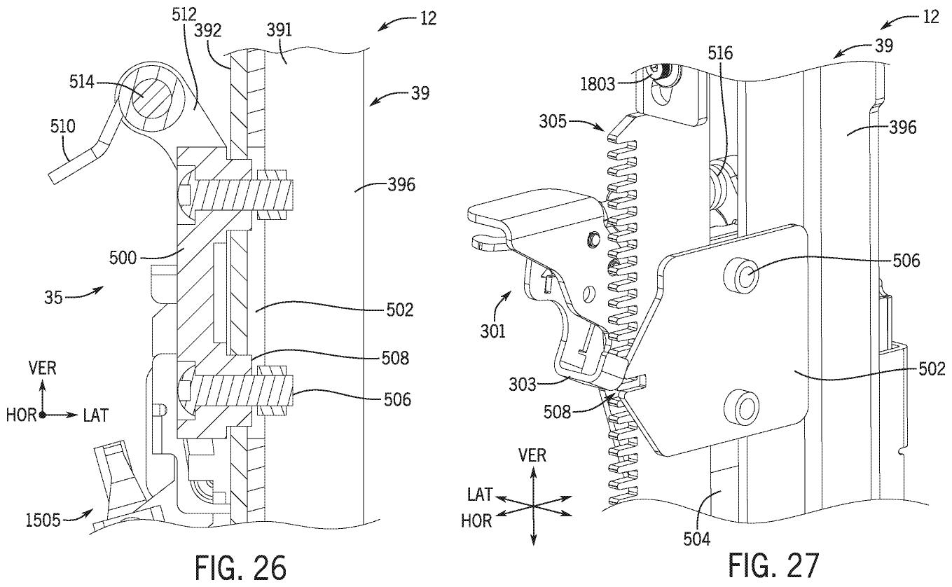

A mounting plate 510 is pivotally coupled to the front plate 500 via brackets 512 and a fastener 514 extending horizontally therethrough. A spring 516 is coiled about the fasteners 514 with ends 518, 520 engaging the front plate 500 and the mounting plate 510. The spring 516 is positioned and wound so as to bias the mounting plate 510 pivotally away from the front plate 500 as shown in FIG. 26. However, the latch 1505 described above is engageable to retain the mounting plate 510 in the locked position (substantially against the front plate 500) as shown in FIG. 25 (mechanisms of the latch 1505 are not shown in the present view).

The carriage 35 and its slidably relative to the frame 39 enable the vertical adjustments discussed above, while also locking in place to allow the entire frame 39 to be moveable (indirectly via the carriage 35) to provide the hands-free unlocking of the clamping head as discussed above for releasing the cylinder 14 upon command.

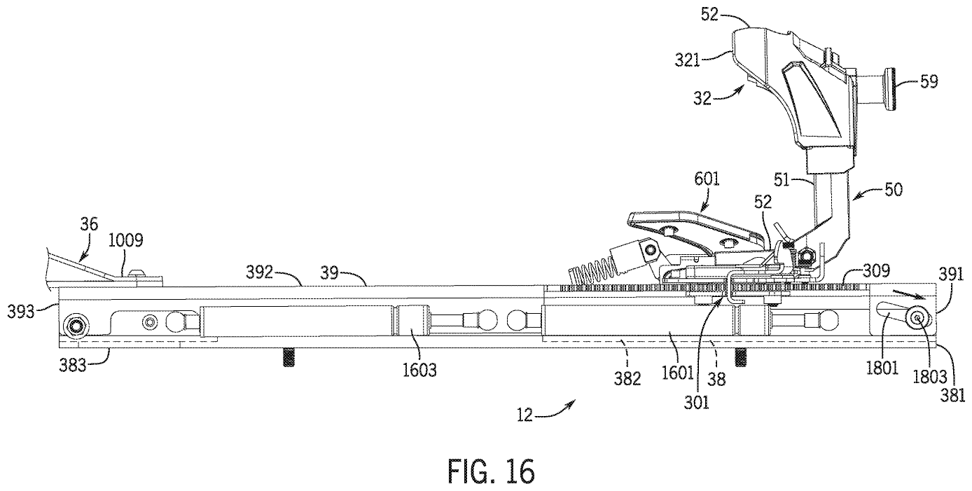

Through further experimentation and development, the present inventors have identified further, optional mechanisms for providing smooth and effective functionality in the hands-free release of the cylinder 14. Referring to FIG. 16, the system 12 comprises dampers 1601 and 1603 that are each coupled at one end to the base 38, and at another end to the frame 39 movable relative thereto. The damper 1601 is configured to resist movement of the frame 39 out of the first position described above, or in other words, vertically upwardly. The present inventors have determined that the damper 1601 assists by preventing accidental movement of the frame 39 relative to the base 38, for example from a user simply getting situated with the seat and/or from a bump in the road, which therefore prevents accidental release of the clamping head 32 from the SCBA cylinder 14. The damper 1601 may be a gas cylinder or other biasing device known in the art. The second damper 1603 acts in an opposing manner to the damper 1601. Specifically, the damper 1603 is configured to resist movement of the frame 39 out of the second position described above, once moved into that position by the user. The damper 1603 ensures that the frame 39 remains in the second position long enough to disengage the latch 1505 and therefore release the SCBA cylinder 14 from the clamping head 32. Without the damper 1603, a user may need to not simply jerk the frame 39 upwardly, but may need to sustain the position for a longer duration, making the task more challenging and potentially less ergonomical.

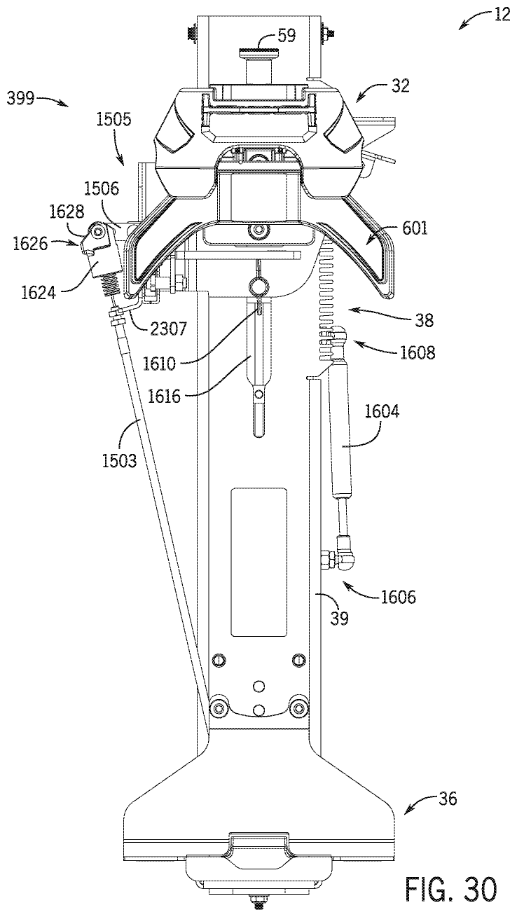

The present disclosure contemplates other embodiments in which only a single damper is present and only dampens movement of the frame 39 in a single direction. Moreover, the present disclosure contemplates other embodiments in which a single damper is provided, but as a double acting damper that dampens movement both directions in a similar manner as the two damper design described above. By way of example, FIG. 30 depicts an embodiment in which a double acting damper 1604 is coupled between the frame 39 and the base 38, which may be a Bansbach Easylift™ HB or MC Damper double acting dampers (e.g., model 100 providing approximately 50 pounds of damping). The double acting damper 1604 may be coupled at a first end 1606 thereof to the frame 39, and at a second end 1608 thereof to the base 38, in a similar manner to gas springs used for automotive trunk lids or doors, such as with universal joints or ball-socket joints. Since double acting dampers are commercially available, further discussion is not provided herein for the sake of brevity. The present inventors have recognized that using a double acting damper 1604 may simplify the assembly process, can reduce the bill of materials for a system, and can provide a smaller overall package and less weight over configurations with two separate dampers.

It should be noted that many of the features disclosed herein can be combined with others in manners not expressly disclosed for the sake of brevity. For example, a given feature may apply to designs with hands-free SCBA releasing, a front cushion release, electric release, hands-free plus electric release, and/or front cushion release plus electric release, etc. By way of example, these features may include the frame moving independently from the base, the dampers, adjustments vertically and/or horizontally, the valve foot and valve cup, manual release, and/or features relating to the clamp head and the functions thereof.

This written description uses examples to disclose the invention, including the best mode, and also to enable any person skilled in the art to make and use the invention. Certain terms have been used for brevity, clarity, and understanding. No unnecessary limitations are to be inferred therefrom beyond the requirement of the prior art because such terms are used for descriptive purposes only and are intended to be broadly construed. The patentable scope of the invention is defined by the claims and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

What is claimed is:

1. A mounting bracket assembly configured for releasably holding an elongated self-contained breathing apparatus (SCBA), the mounting bracket assembly comprising:
a base;
a frame movably coupled to the base;
a head pivotably coupled to the frame so as to move therewith relative to the base, wherein the head is pivotable between a closed position to retain the SCBA with the frame and an open position in which the SCBA is removeable from the frame; and
a latch engageable to lock the head in the closed position, wherein the latch is coupled to the frame so as to move therewith relative to the base, and wherein the latch is operatively coupled such that moving the frame relative to the base causes the latch to disengage to thereby allow the head to pivot towards the open position.

2. The mounting bracket assembly according to claim 1, further comprising a cable coupled to the latch, wherein moving the frame relative to the base tensions the cable to disengage the latch.

3. The mounting bracket assembly according to claim 1, wherein the frame is movably coupled to the base such that the frame is movable only non-orthogonally relative to the base.

4. The mounting bracket assembly according to claim 3, wherein the latch is configured to be disengaged by simultaneously moving the frame upwardly and towards the base.

5. The mounting bracket assembly according to claim 1, wherein the frame is movable relative to the base between a first position and a second position, wherein gravity forces the frame towards the first position, and wherein the latch is engaged when the frame is in the first position.

6. The mounting bracket assembly according to claim 5, further comprising a damper that resists movement of the frame towards the second position so as to prevent accidental disengagement of the latch.

7. The mounting bracket assembly according to claim 5, further comprising a damper that resists movement of the frame towards the first position to allow the latch to disengage before the frame moves away from the second position.

8. The mounting bracket assembly according to claim 7, wherein the damper is a double acting damper that also resists movement of the frame towards the second position so as to prevent accidental disengagement of the latch.

9. The mounting bracket assembly according to claim 1, wherein the head is coupled to the frame via a carriage that is vertically movable relative to the base, wherein the head is coupled to the carriage so as to move therewith and the head is configured to vertically clamp the SCBA to secure the SCBA to the frame, further comprising a lock selectively engageable to prevent vertical movement of the carriage relative to the base, and further comprising a handle operatively coupled to the lock and configured to be manually moved by a user, wherein moving the handle disengages the lock to allow for vertically positioning the head for clamping the SCBA.

10. The mounting bracket assembly of claim 9, wherein the handle is pivotable by the user to disengage the lock.

11. The mounting bracket assembly of claim 10, wherein the handle is pivotably coupled to the carriage to move therewith, wherein the lock comprises a rack coupled to the frame, and wherein a pawl is selectively engageable with the rack by pivoting the handle.

12. The mounting bracket assembly of claim 9, wherein the handle is biased by a spring into a lock position in which the lock is engaged, whereby manually moving the handle overcomes the spring to disengage the lock.

13. The mounting bracket assembly of claim 9, wherein the base is configured to be coupled to a vehicle seat, and wherein the handle is pivotable within a plane that is substantially parallel to a back of the vehicle seat.

14. The mounting bracket assembly of claim 9, wherein the head clamps down on the SCBA, and wherein the handle is manually moved upwardly to disengage the lock.

15. The mounting bracket assembly of claim 1, wherein the head is movably coupled to an arm that extends away from the base, wherein a plurality of openings extend through the arm, and wherein adjacent openings within the plurality of openings overlap so as to be open to each other, further comprising a lock selectively engageable with the plurality of openings in the arm, wherein selecting which of the plurality of openings the lock engages adjusts and locks a position of the head relative to the arm for securing the SCBA to the seat.

16. The mounting bracket assembly of claim 15, wherein the plurality of openings comprises a plurality of crescent-shaped openings.

17. The mounting bracket assembly of claim 15, wherein the lock comprises a plunger insertable within the plurality of openings to lock the position of the head relative to the arm.

18. The mounting bracket assembly of claim 1, further comprising:
a foot having a first end coupled to the frame and extending away therefrom to a second end with a midsection therebetween, wherein the foot is configured to support the SCBA, wherein the foot has a ramp that ramps downwardly from the first end to the midsection; and
a cup positioned in the midsection, wherein the cup is configured to receive a valve of the SCBA therein to prevent movement of the valve relative to the foot;
wherein the ramp is configured to guide the valve towards the midsection and thereby assist a user in positioning the valve of the SCBA in the cup.

19. The mounting bracket assembly according to claim 18, wherein the cup has an opening comprising at least two different shapes to thereby accommodate different configurations for the valve.

20. The mounting bracket assembly according to claim 18, wherein the cup is removable from the midsection and positionable therein in at least two positions, and wherein the cup has an opening that is asymmetrical such that in a first of the at least two positions the opening is configured to receive a first valve type as the valve therein and in a second of the at least two positions the opening is configured to receive a second valve type as the valve therein.

21. The mounting bracket assembly according to claim 18, wherein the foot is configured to be coupled to the frame in at least two positions so as to be adjustable relative thereto.

22. The mounting bracket assembly according to claim 1, wherein the mounting bracket assembly is coupled to a seat cushion, further comprising a release handle moveably coupled to the seat cushion, and further comprising a cable coupled to the release handle and to the latch, wherein moving the release handle relative to the seat cushion tensions the cable to disengage the latch.
